(19) United States
(12) Patent Application Publication
(10) Pub. No.: US 2022/0232937 A1
(43) Pub. Date: Jul. 28, 2022

(54) AUTOMOBILE DOCUMENT CASE

(71) Applicant: Susan Diane Thompson-Pope, Bath, MI (US)

(72) Inventor: Susan Diane Thompson-Pope, Bath, MI (US)

(21) Appl. No.: 16/974,426

(22) Filed: Jan. 28, 2021

(51) Int. Cl. A45C 11/00; A45C 13/10

(52) U.S. Cl. CPC A45C 11/00; B68F 1/00; A45C 13/1076

(57) ABSTRACT

Safer Stops is a 4.5″ X 4.5″ octagonal case mounted on the steering cowl used to house driving documents requested during a typical traffic stop to prevent the drivers hands from leaving site of the police officer. Safer Stops consist of two octagonal pieces of leather sewn together on five connecting sides of the eight. The three sides not sewn together form an opening which is secured with a snap closure. On the back is a 3′ round sticky re-useable gel pad. One Side of the gel pad sticks to the case the other side sticks to the steering cowl. The device comes in many colors and is branded with the Safer Stops logo.

### FIELD OF INVENTION

Driver Safety

### BACKGROUND

The background of the Safer Stops case is it Is a driver safety product.

### Summary

The Safer Stops case is designed to hold the documents requested in a routine traffic stop, (license, proof of insurance and vehicle registration, thus making it unnecessary to reach in pockets, glove compartments or purses to retrieve required documents.

Safer Stops is mounted on the steering cowl therefore drivers can keep their hands on the steering wheel and in view of the officer.

The Safer Stops case was developed to keep drivers safer during traffic stops.

A) A Written Description of Invention

The Safer Stops case is two pieces of 4.5″ X 4.5″ leather octagonal pieces sewn together on five of the eight sides.

The case is ¼ in thick.

The case has one snap closure on the top.

The case is adapted to be mounted on the car with a silicon gel pad which allows it to adhere to the steering column cowl of any motor vehicle.

The words ‘Safer Stop Safer” are printed or embossed on the front.

The case comes in a variety of colors.

B) The Manner and Process of Making the Invention

Safer Stops case is die cut in a octagon shape. It is sewn together on five sides and open on the top 3 edges.

The device is then printed or embossed. Finally a snap is installed on the top edge of the case.

C) The Best Mode Contemplated By the Inventor of Carrying Out Invention

The Safer Stops device is mass produced in a cut and sew facility and will be marketed to the public via online sales.

### D) BACKGROUND OF THE INVENTION

The background of the Safer Stops case is safety. Safety for all drivers. This is why I developed it. Safety For my family and yours

FIG. 1

### DESCRIPTION OF DRAWINGS SAFER STOPS DRAWING FRONT

Shows front of Safer Stops case

Shows front of snap closure

Shows where stitching ends to allow for opening

Shows where stitching is located

Shows where all print/decoration is located

Shows measurement of each side

FIG. 1A

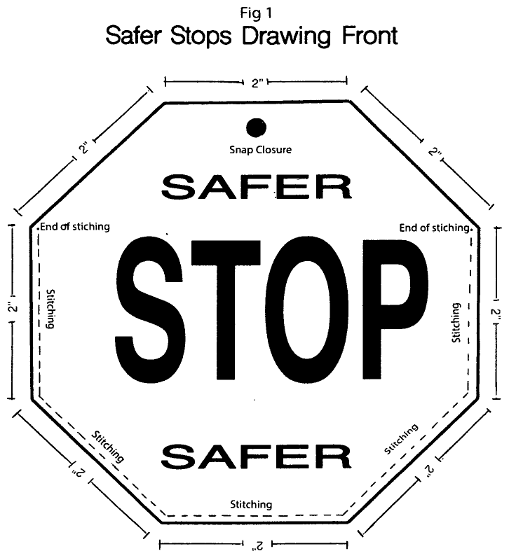

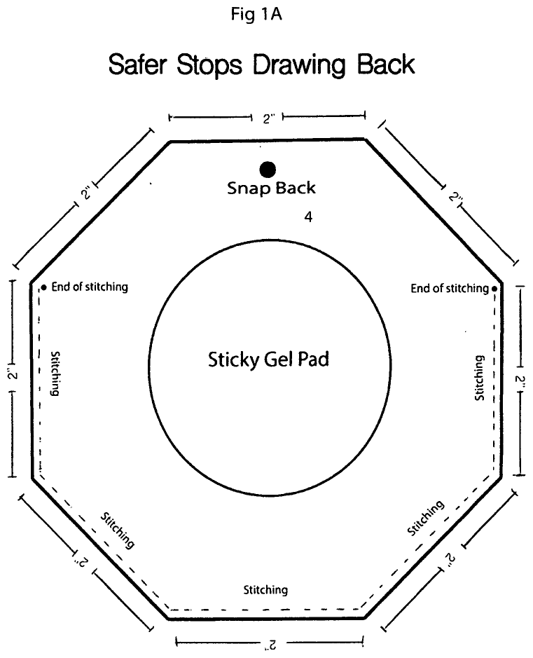

### DESCRIPTION OF DRAWINGS SAFER STOPS DRAWING BACK

Shows back of snap closure

Shows where stitching ends to allow for opening

Shows where stitching is located

Shows location of gel pad that holds case in place

Shows measurement of each octagon side

1. (canceled)

2. A case for keeping a driver and a police officer safer during an encounter between the driver and the police officer, the case comprising:
a first rigid flat polygonal piece defining a plurality of sides, the first rigid flat octagonal piece between any one of the sides to the remaining sides being contiguous in a straight line;
a second rigid flat polygonal piece being separate from the first rigid flat polygonal piece, the second rigid flat polygonal piece defining a plurality of sides, the second rigid flat octagonal piece between any one of the sides to the remaining sides being continuous in a straight line, the second rigid flat octagonal piece having a corresponding dimension compared to the first rigid flat octagonal piece so that the first and second rigid flat octagonal pieces remain flat when sewn to each other;
a permanent attachment mechanism about only a portion of a circumference of the first and second rigid flat polygonal pieces;
a temporary attachment mechanism having first and second parts which are removably attachable to each other, the first part attached to the first rigid flat polygonal piece, the second part attached to the second rigid flat polygonal piece, the first and second parts being positioned at the same location so that the first and second parts contact each other when the case is in a closed position;
an adhesive attached to an exterior surface of either one of the first and second rigid flat polygonal pieces;
wherein an interior size of the case defined by the permanent attachment mechanism and the temporary attachment mechanism is larger than a driver's license.

3. The case of claim 1 wherein the first and second flat polygonal pieces has 8 sides.

4. The case of claim 1 wherein the first and second flat polygonal pieces is fabricated from leather.

5. The case of claim 3 wherein the first and second flat polygonal pieces is attached on five immediately adjacent sides with the permanent attachment mechanism.

6. The case of claim 5 wherein the permanent attachment mechanism is a thread sewn into side portions of the first and second flat polygonal pieces.

7. The case of claim 5 wherein the temporary attachment mechanism is attached adjacent to one of the three remaining sides without the permanent attachment mechanism.

8. The case of claim 7 wherein the temporary attachment mechanism is a snap for quick release and removal of contents within the case.

9. The case of Claim8 wherein a flap may be lifted up to expose the contents within the case.

10. The case of claim 1 wherein the adhesive is a reusable silicone gel pad for securing the case to a cowl of a steering column of an automobile.

11. The case of claim 1 wherein an exterior size of the case is 5 inches by 5 inches.

12. The case of claim 1 wherein safer stop safer is imprinted on an exterior surface of one of the first and second rigid flat polygonal pieces.

13. The case of claim 1 wherein the temporary attachment mechanism.
